(19) United States
(12) Patent Application Publication
(10) Pub. No.: US 2007/0095468 A1
(43) Pub. Date: May 3, 2007

(54) SEALANT DISPENSING APPARATUS, LIQUID CRYSTAL DISPLAY PANEL MANUFACTURED USING THE SAME AND METHOD OF MANUFACTURING LIQUID CRYSTAL DISPLAY PANEL

(76) Inventors: Sun Hyung KIM, Asan-Si (KR); Yeon Cu Kim, Asan-Si (KR)

Correspondence Address: F. CHAU & ASSOCIATES, LLC, 130 WOODBURY ROAD, WOODBURY, NY, 11797, US

(21) Appl. No.: 11/554,864

(22) Filed: Oct. 31, 2006

(30) Foreign Application Priority Data
Nov. 2, 2005 (KR) 10-2005-0104445

(51) Int. Cl. B32B 37/00

(52) U.S. Cl. 156/275.3; 118/506; 428/1.5

(57) ABSTRACT

The present invention relates to a sealant dispensing apparatus, a liquid crystal display panel manufactured using the sealant dispensing apparatus, and a method of fabricating the liquid display panel. The sealant dispensing apparatus. Comprises a body having an injection nozzle, a partition plate for dividing the interior of the body, into at least two spaces, and an injection pressure application section for applying an injection pressure to the spaces divided by the partition plate. A liquid crystal display panel manufactured using the sealant dispensing apparatus, comprises upper and lover substrates, a sealing pattern formed along edges of opposite upper and lower substrates, and liquid crystal interposed inward of the sealing pattern, wherein the sealing pattern comprises at least two kinds of sealants whose mixing ratio is changed along a widthwise direction of the sealing pattern.

### BACKGROUND OF THE INVENTION

1. Technical Field

The present disclosure relates to a sealant dispensing apparatus, a liquid crystal display panel manufactured using the sealant dispensing apparatus, and a method of manufacturing the liquid crystal display panel. More particularly, the present disclosure relates to a sealant dispensing apparatus, wherein curing agents having different natures are simultaneously dispensed at the inner and outer sides to prevent leakage of the liquid crystal

2. Discussion of the Related Art

A liquid crystal displays (LCD) device, when compared with a conventional cathode ray tube (CRT) is lightweight, thin and can include a large display window. The LCD device can function as a fiat display device, and has been used as a display device of, for example, a cellular phone, PDA, digital camera and camcorder, and has also been used as a monitor for a desktop computer and a larger scale display device. That is, the application range of the LCD device has been rapidly increased. An LCD device produces a high quality image including such features as high definition, high brightness and large display area while maintaining a lightweight and compact construction and low power consumption.

A liquid crystal panel of an LCD device includes a lower substrate having pixel electrodes and thin film transistors in a liquid crystal region and an upper substrate including common electrodes and color filters in the liquid crystal region. Liquid crystal is charged and sealed between the two substrates. The substrates are, in turn, are bonded with each other.

Conventionally, a liquid crystal injection method in which two substrates are bonded with each other and liquid crystal is then injected between the substrates has been employed. For example, an epoxy-based sealant is first coated along edges of the liquid crystal regions in the lower and upper substrates in such a manner that the sealant is not coated in a liquid crystal injection hole region through which the liquid crystal is injected. Then, the two substrates are overlapped and aligned and pressed at a temperature of above about 200° C. such that the epoxy-based sealant can be cured to form a sealing pattern for bonding the substrates with each other. At this time, due to the sealing pattern, a desired cell gap is provided between the upper and lower substrates. Next, the cell gap is vacuumed and liquid crystal is then injected between the upper and lower substrates using the capillary phenomenon and pressure difference. After injecting the liquid crystal, the liquid crystal injection hole is sealed to complete the liquid crystal display panel.

In the above conventional method, since liquid crystal should be injected through a small liquid crystal injection hole, there the liquid crystal slowly penetrates into the panel and thus productivity is decreased. In a case where the liquid crystal injection hole is expanded in order to improve the productivity, the sealing effect obtained by the epoxy-based sealant is deteriorated.

Therefore, a liquid crystal drop method has been proposed. In the liquid crystal drop method, liquid crystal is dropped on a substrate when forming a sealing pattern and the substrates are then bonded to each other.

The epoxy-based sealant has a thermosetting property, and should be pressed at a high temperature such that it can be cured. For example, when an epoxy-based sealant is coated on the substrate and liquid crystal is then dropped thereon, the two substrates are stacked one above another and then pressed at a high temperature to form a sealing pattern for sealing a liquid crystal region. Then, liquid crystal is charged and sealed in the liquid crystal region within the sealing pattern. In a case where a thermosetting epoxy-based sealant is used in the conventional liquid crystal drop method, the electrical and optical properties of the liquid crystal may be lost

Accordingly, research for using an acrylic-based sealant having a photocurable property instead of using the epoxy-based sealant has been performed. For example, an acrylic-based sealant is coated on a substrate and liquid crystal is then dropped thereon. Then, the two substrates are stacked one above another and the acrylic-based sealant is cured by means of ultraviolet (UV) light to form a sealing pattern, in which the liquid crystal is charged. It is known to mix an epoxy-based thermosetting sealant with the acrylic-based photocurable sealant since sufficient adhesive strength has not been obtained only with the acrylic-based photocurable sealant.

Where the acrylic-based photocurable sealant is employed, uncured acrylic-based photo curable sealant contacts and reacts with the liquid crystal. As a result, foreign substances and contaminants are produced, which can produce a defective device. For example, in a liquid crystal drop process, two substrates with liquid crystal dropped thereon are stacked and pressed, and light is then irradiated to cure the sealant. At this time, the liquid crystal is spread due to the pressing of the substrates. When the sealant, which has not completely cured, is brought into contact with the spreading liquid crystal, the foreign substances and contaminants are produced. In addition, such foreign substances and contaminants can result in defects such as, for example, residual images on the LCD device and stains in the display area.

Furthermore, a UV shielding film can exist in the liquid crystal display panel such that UV cannot be irradiated over a sufficient area. Therefore, the acrylic-based sealant remains in the sealing pattern in a state where it is not completely cured. If the temperature of the liquid crystal panel is increased to thermally cure the sealant, the molecular motion of the acrylic-based sealant is promoted to thereby cause a risk of diffusing the sealant into the liquid crystal layer.

### SUMMARY OF THE INVENTION

In accordance with embodiments of the present invention, there is provided a sealant dispensing apparatus, a liquid crystal display panel manufactured using the sealant dispensing apparatus, and a method of manufacturing the liquid crystal display panel, in which inner and outer sides adjacent to a liquid crystal region are coated with sealants having different properties to prevent bursting of liquid crystal dropping the liquid crystal and to prevent the generation of by-products due to a reaction between the liquid crystal and uncured sealant. The different sealants can be simultaneously coated on the inner and outer sides.

According to an embodiment of the present invention, a sealant dispensing, apparatus comprises a body having an injection nozzle, a partition plate for dividing the interior of the body into at least two spaces, and an injection pressure application section for applying an injection pressure to the spaces divided by the partition plate.

The interior of the body can be divided into first and second spaces by the partition plate.

The sealant dispensing apparatus may further comprise a sealant mixing ratio control member for controlling a mixing ratio of sealants in the mixed sealant. The sealant mixing ratio control member may include a barrier installed in the injection nozzle. Further, the barrier may be rotatably installed and the mixing ratio of sealants in the mixed sealant may vary, with an angle defined by the barrier and the partition plate. Furthermore, the sealant mixing ratio control member may include an injection pressure controller for controlling the injection pressure of the injection pressure application section.

When a width of the injection nozzle is defined as one (1), a width of the first space of the injection nozzle is within a range of about 0.01 to about 0.8, a width of the second space of the injection nozzle is within a range of about 0.01 to about 0.8.

The partition plate may extend from an upper end of the injection nozzle to an upper portion of the body.

The sealant dispensing apparatus may further comprise a rotating member for rotating the body.

According to another embodiment of the present invention, there is provided a liquid crystal display panel, which comprises upper and lower substrates positioned opposite to each other, a sealing pattern formed along edges of the opposite upper and lower substrates, and liquid crystal interposed inward of the sealing pattern, wherein the sealing pattern comprises at least two sealants whose mixing ratio is changed in a widthwise direction of the sealing pattern.

Inner and outer sides of the sealing pattern can be provided with first and second sealants 203 having different curing rates, respectively. The first and second sealants may have different curing rates based on temperature. The first and second sealants may have different curing rates based on light polymerization. The first sealant may be an acrylic-based or epoxy-acrylic hybrid based sealant, and the second sealant may be an epoxy-based sealant.

A mixed sealant of the epoxy-based sealant or epoxy-acrylic hybrid based sealant and the acrylic-based sealant may be formed on an interface of the two sealants.

When a width of the sealing pattern is defined as one (1), a width of the first sealant is within a range of about 0.01 to about 0.8, a width of the second sealant is within a range of about 0.01 to about 0.8, and a width of the mixed sealant is no more than about 0.95.

A color filter substrate with a color filter formed thereon may be used as the upper substrate and a TET substrate with a TFT pattern formed thereon may be used as the lower substrate.

According to another embodiment of the present invention, a method of fabricating a liquid crystal display panel, comprises the steps of preparing a lower substrate with a pixel pattern formed thereon and an upper substrate with a color filter pattern formed thereon; forming a sealing pattern along edges of at least one of the lower and upper substrates, the sealing pattern comprising a first sealant provided on an inner side thereof and a second sealant provided on an outer side thereof; dropping liquid crystal inside of the sealing pattern; bonding the lower and upper substrates in such a manner that the color filter pattern and the pixel pattern are aligned to each other, and irradiating LV onto the substrates to cure the second sealant provided in the outer side of the sealing pattern; and performing heat treatment to cure the uncured sealant of the sealing pattern

The step of forming the sealing pattern may comprise the steps of securely placing the lower or upper substrate on a movable and rotatable stage; and coating a sealant onto edges of the lower or upper substrate using a sealant dispensing apparatus while moving and rotating the stage, wherein the sealant dispensing apparatus includes first and second spaces in which first and second sealants are accommodated, respectively.

The first and second sealants may, have different curing rates based on temperature and light polymerization, and the first sealant may be an acrylic-based sealant or epoxy-acrylic hybrid based sealant, and the second sealant may be an epoxy-based sealant.

The step of forming the sealing pattern may comprise securing the lower or upper substrate on a movable stage: coating the first and second sealants onto the edges of the lower or upper substrate using a sealant dispensing apparatus while laterally moving the stage, the sealant dispensing apparatus including first and second spaces for accommodating the first and second sealants, respectively; and rotating the sealant dispensing apparatus such that the first sealant is coaled inward of the second sealant.

### BRIEF DESCRIPTION OF THE DRAWINGS

Exemplary embodiments of the present invention can be understood in more detail from the following description taken in conjunction with the accompanying drawings, in which:

FIG. 1 is a perspective view of a liquid crystal display panel according to an embodiment of the present invention;

FIG. 2 is a sectional view taken along line A-A of FIG. 1;

FIG. 3a is a graph showing a curing time of an epoxy-based sealant as a function of molecular weight;

FIG. 3b is a graph showing a curing time of an acrylic-based sealant as a function of molecular weight;

FIGS. 4 and 5 show a sealant dispensing apparatus according to an embodiment of the present invention;

FIG. 6 shows a composition ratio of a sealant coated on a substrate by the sealant dispensing apparatus according to an embodiment of the present invention;

FIG. 7 shows nozzle regions of the sealant dispensing apparatus according to an embodiment of the present invention;

FIG. 8 shows composition ratios of a sealant coated on a substrate according to an embodiment of the present invention; and

FIGS. 9 to 11 are perspective views illustrating a method of manufacturing a liquid crystal display panel according to an embodiment of the present invention.

### DETAILED DESCRIPTION OF THE EXEMPLARY EMBODIMENTS

Exemplary embodiments of the present invention will be described in detail with reference to the accompanying drawings. The present invention may, however, be embodied in many different forms and should not be construed as being limited to the embodiments set forth herein.

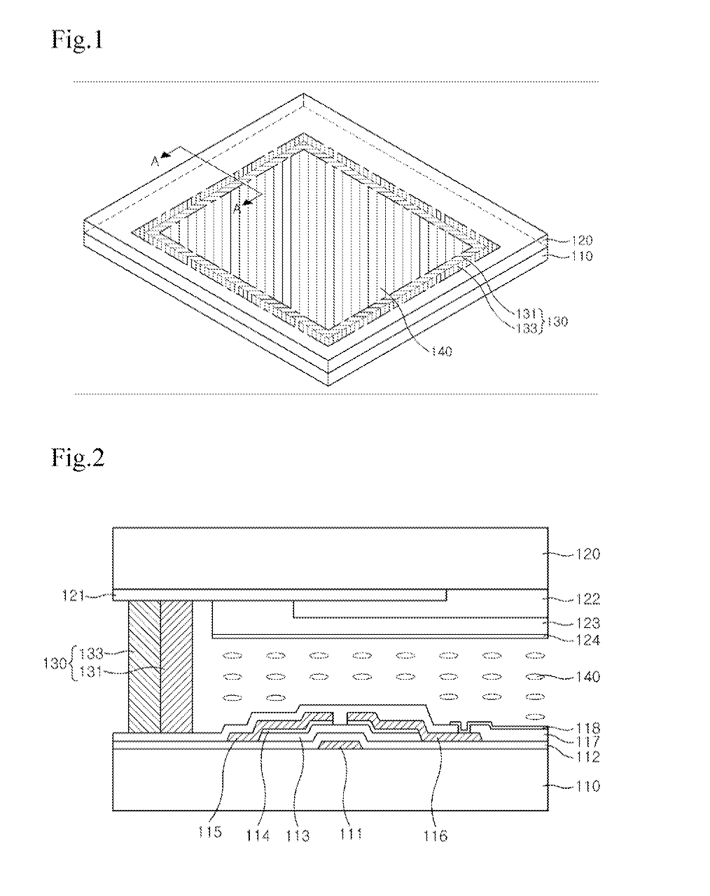

FIG. 1 is a perspective view of a liquid crystal display panel according to an embodiment of the invention and FIG. 2 is a sectional view taken along line A-A of FIG. 1.

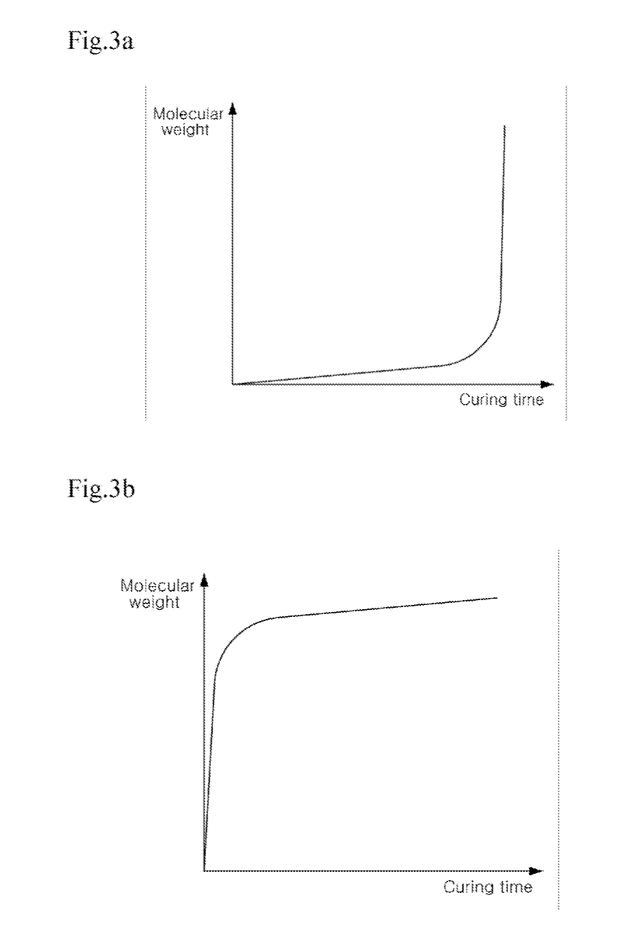

FIG. 3a is a graph showing a curing time of an epoxy-based sealant, and FIG. 3b is a graph showing a curing time of an acrylic-based sealant.

Referring to FIGS. 1 and 2, the liquid crystal display (LCD) device includes upper and lower substrates 120 and 110 of an LCD panel, a sealing pattern 130 formed along edges of the opposite upper and lower substrates 120 and 110, and liquid crystal 140 interposed between the upper and lower substrates and inward of the sealing pattern 130.

A color filter substrate with a color filter formed thereon may be used as the upper substrate 120, and a thin-film transistor (TFT) substrate with a TFT pattern formed thereon is used as the lower substrate 110. On the lower substrate 110 are formed a plurality of gate lines arranged at regular intervals in one direction, a plurality of source lines arranged at regular intervals perpendicular to the gate lines, a plurality of pixel electrodes 118 formed in a matrix form on a pixel region defined by the gate lines and source lines intersecting each other, and a plurality of thin film transistors which are switched by gate line signals to transmit source line signals to the respective pixel electrodes. Each of the thin film transistors includes a gate electrode ll1, a gate insulation film 112, an active layer 113 and ohmic contact layer 114, a source electrode 115 and a drain electrode 116. A protective layer 117 is further provided for insulation between the thin film transistor and the pixel electrode 118. In addition, on the upper substrate 120 are formed a black matrix layer 121 for blocking light from portions other than the pixel region, an R/G/B color filter layer 122 for displaying a color image, an overcoat layer 123 for protecting the color filter layer 122, and a common electrode 124 for implementing an image.

In addition, the sealing pattern 130 comprises at least two kinds of sealant having different compositions. The sealants may be coated simultaneously, using a single sealant dispensing apparatus, which will be described further below. An area to be brought into contact with the liquid crystal 140 is coated with a sealant not reacting with the liquid crystal 140, and the remaining areas are coated with a sealant having a higher curing rate.

As illustrated in FIG. 1, the sealing pattern 130 is formed in a band form along the edges of the opposite upper and lower substrates 120 and 110. The inner and outer sides of the sealing pattern 130 are coated with sealants having different curing rates Sealants having different curing rates due to heat and/or light polymerization may be used as the sealants having the different curing rates.

The sealing pattern 130 is formed in such a manner that an epoxy-based thermosetting sealant 131 is provided at the inner side thereof and an acrylic-based photocurable sealant 133 is provided it the outer side thereof. Alternatively, an epoxy-acrylic hybrid based sealant may be provided at the inner side of the sealing pattern 130, instead of the epoxy-based thermosetting sealant 13l.

The epoxy-based sealant 131 is a thermosetting resin and causes condensation polymerization. As shown in FIG. 3a, therefore, the epoxy-based sealant has a lower polymerization rate than the acrylic-based sealant 133 but exhibits good adhesive strength and lower absorption. In addition, the epoxy-based sealant 131 has low reactivity with a liquid crystal 140, and thus, foreign substances and contaminants are not produced. Therefore, the epoxy-based sealant 131 is coated onto the area brought into contact with the liquid crystal 140 to avoid the chemical reaction with the liquid crystal 140. The acrylic-based sealant 133 is a UV-curable resin and causes chain polymerization. As shown in FIG. 3b therefore, the acrylic-based sealant has a higher polymerization rate than the epoxy-based sealant 131, but provides relatively lower adhesive strength. In addition the acrylic-based sealant 133 reacts with the liquid crystal before it is cured. Therefore, an acrylic-based sealant 133 is disposed outwards of an epoxy-based sealant 131 such that the acrylic-based sealant can be rapidly cured to prevent the liquid crystal 140 from leaking to the outside when the two substrates are pressed. An epoxy-acrylic hybrid sealant exhibits hybrid properties of the epoxy-based sealant 131 and the acyclic-based sealant 133. The acrylic-based sealant can be cured by heat, but the epoxy-based sealant cannot be cured by UV.

As described above, the high curing rate of the acrylic-based sealant 133 provides an improved hardness of the sealing pattern 130, thereby preventing bursting of the sealing pattern 130 due to the diffused liquid crystal. The epoxy-based sealant 131 has a lower curing rate but has a good curing rate due to heat and adhesive strength as compared to the acrylic-based sealant 133. Thus, uncured acrylic-based sealant 133 can be prevented from diffusing into the liquid crystal region and the adhesive strength between the two substrates 110 and 120 can be improved. Furthermore, the generation of foreign substances and contaminants due to reaction with the liquid crystal can be avoided. The epoxy-based sealant and the acrylic-based sealant are simultaneously coated to take advantage of the properties of both sealants.

Hereinafter, a sealant dispensing apparatus capable of simultaneously coating sealants having different characteristics to form the aforementioned sealing pattern will be explained.

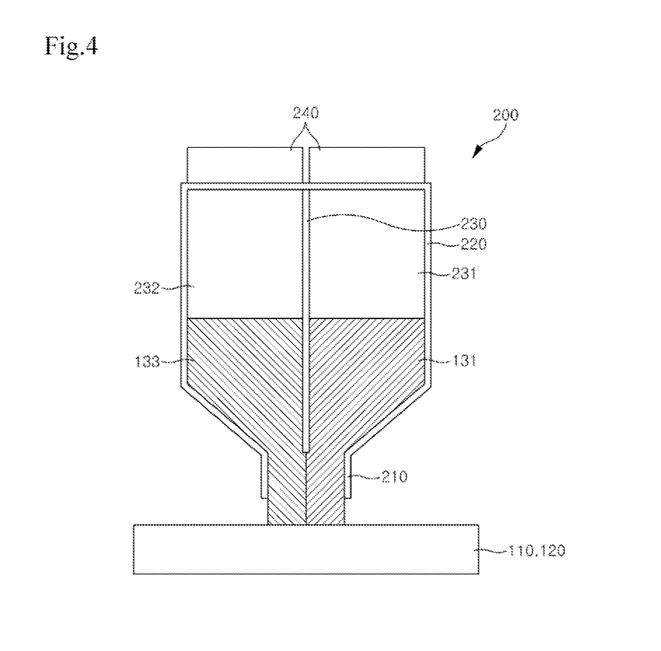

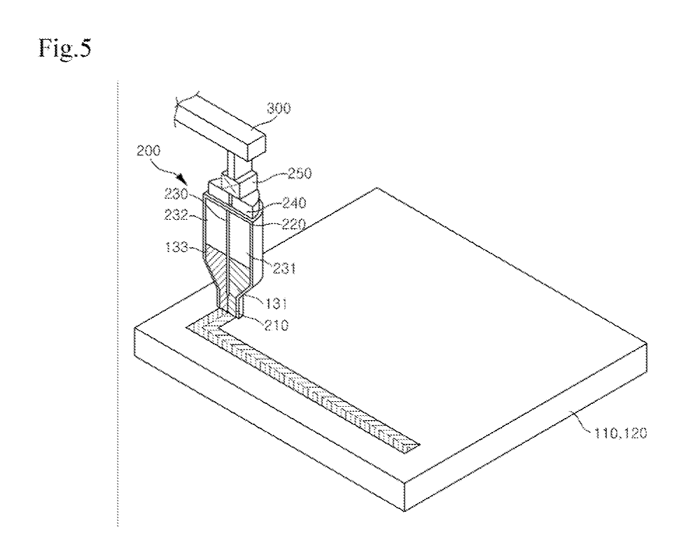

FIGS. 4 and 5 are views illustrating a sealant dispensing apparatus according to an embodiment of the present invention.

Referring to FIGS. 4 and 5, the sealant dispensing apparatus 200 includes a body 220 having an injection nozzle 210, a partition plate 230 for dividing the interior of the body 220 into at least two spaces, and an injection pressure application section 240 for applying injection pressure to the two spaces 231 and 232 divided by the partition plate 230. The body 220 is divided into the first and second spaces 231 and 232 by the partition plate 230. The first and second spaces 231 and 232 are accommodated with first and second sealants having different curing rates, respectively. Sealants having the different curing rates due to heat and/or light polymerization are used as the first and second sealants. For example, the first space 231 includes the epoxy-based sealant 131 and the second space 232 includes the acrylic-based sealant 133.

The partition plate 230 extends from an upper end of the injection nozzle 210 to an upper portion of the body 220. Thus, the epoxy-based sealant 131 and the acrylic-based sealant 133 can be separated from each other in the body 220 in such a state where they remain unmixed with each other. The body 220 may be either evenly divided or unevenly divided by the partition plate 230 depending on the injection pressure and the amount of sealant injected.

The injection pressure application section 240 is configured in such a manner that the epoxy-based sealant 131 and the acrylic-based sealant 133 in the first and second spaces 231 and 232 can be injected out of the apparatus 200 at a uniform pressure through the injection nozzle 210. Different injection pressures may be applied to the first and second spaces 231 and 232. The injection pressure application section 240 may, for example, employ a mechanical means such as a piston or apply air pressure to the first and second spaces 231 and 232 to inject the sealants 131 and 133 to the outside.

In addition, as shown in FIG. 5, the sealant dispensing apparatus 200 can apply the sealants onto substrates 110 and 120 while the substrates are moving, and the sealant dispensing apparatus is fixed to a shaft 300.

For example, in order to apply a sealant along the edge of the rectangular glass substrates 110 and 120. the sealant is continuously coated while changing the direction of the movement of the glass substrates 10 and 120 laterally by 90 degrees at the corner area thereof without rotation and at the same time the sealant dispensing apparatus 200 should rotate by 90 degrees.

A rotating member 250 for rotating the sealant dispensing apparatus 200 is further provided. That is, in a case where the direction of the movement of the substrates 100 and 120 is changed laterally without rotation the body 220 of the sealant dispensing apparatus 200 is also preferably rotated by 90 degrees. By means of the rotating member 250, the inner sides of the edges of the rectangular substrates 110 and 120 can be coated with the epoxy-based sealant 131 and the outer sides thereof can also be coated with the acrylic-based sealant 133.

When an injection pressure is applied to the first and second spaces 231 and 232 divided by the partition plate 230 through the injection pressure application section 240, the epoxy-based sealant 131 in the first space 231 and the acrylic-based sealant 133 in the second space 232 are injected through the injection nozzle 210. At this time, the two sealants which have been separated by the partition plate 230 are brought into contact with each other within the injection nozzle.

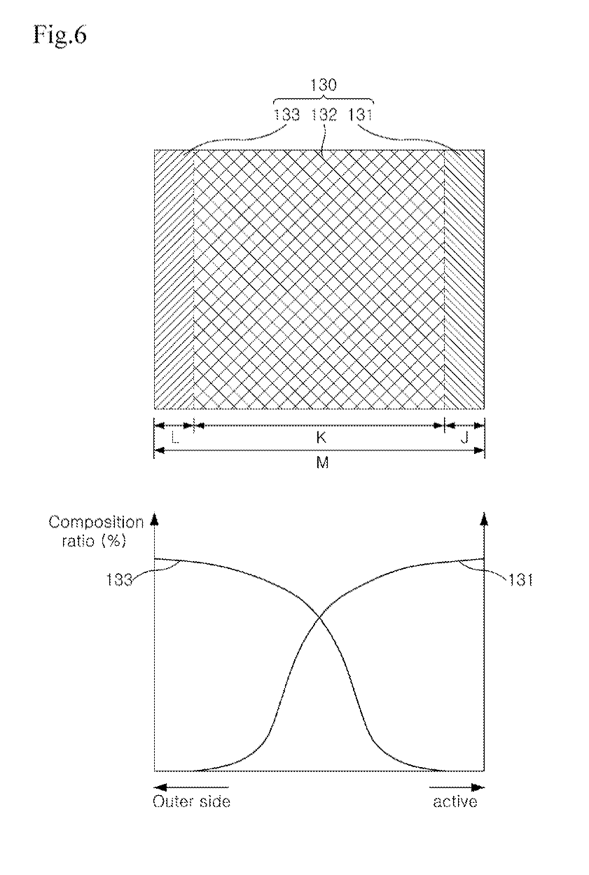

FIG. 6 is a graph showing the composition ratio of sealants coated by the sealant dispensing apparatus according to an embodiment of the present invention.

As shown in FIG. 6, in a case where two different sealants are coated onto the substrates 110 and 120 by means of the sealant dispensing apparatus 200 for simultaneously injecting the two sealants, the acrylic-based sealant 131 and the epoxy-based sealant 133 are mixed within the injection nozzle 210 of the sealant dispensing apparatus 200. Accordingly, the sealant layer coated on the substrates 110 and 120 is composed of an epoxy-based sealant 131 at its inner side, an acrylic-based sealant 133 at its outer side, and a mixed sealant 132 at an intermediate region corresponding to an interface of the inner and outer sides.

Referring to FIG. 6, the relationship between the width of the epoxy-based sealant 131, the acrylic-based sealant 133, and the mixed sealant is defined. For example, if the total width M of the whole sealant layer formed on the substrate is one (1), the width J of the epoxy-based sealant 131 is within a range of about 0.05 to about 0.8, for example, within a range of about 0.05 to about 0.5. In addition, the width L of the acrylic-based sealant 133 is within a range of about 0.01 to about 0.8, for example, within a range of about 0.05 to about 0.5. The width can vary with the degree of spreading of the liquid crystal 140 between two substrates 110 and 120, the magnitude of pressing force exerted on the substrates 110 and 120, the curing characteristics of the sealants, and the injection pressure of the sealant dispensing apparatus 200. The widths of the epoxy-based sealant 131 and the acrylic-based sealant 133 represent the widths of regions, respectively, where pure acrylic-based and epoxy,-based sealant compositions exist.

In addition, for example, the mixed sealant 132 has a width K of no more than about 0.95. The two different sealants can be mixed with each other at their interface when they are brought into contact with each other. The mixing degree of the sealants can vary with the coating conditions as well as the characteristics of the sealants. Here. the width of the mixed sealant 132 is a width of a region occupied by the mixture of the acrylic-based sealant 133 and the epoxy-based sealant 131. Depending on the characteristics of the two sealants to be mixed, the mixed sealant 132 may not be formed at all or may be slightly formed.

The sealant dispensing apparatus according to an embodiment of the present invention may further include a sealant mixing ratio controller for controlling the mixing ratio of the mixed sealant. Hereinafter, an embodiment of the present invention in which a barrier is included in the injection nozzle as the sealant mixing controller will be explained. It is to be understood that the present invention is not limited to the following description but may employ a variety of members capable of controlling the mixing ratio of the mixed sealant. For example, an injection pressure controller for controlling the injection pressure of sealants may be used as the sealant mixing controller.

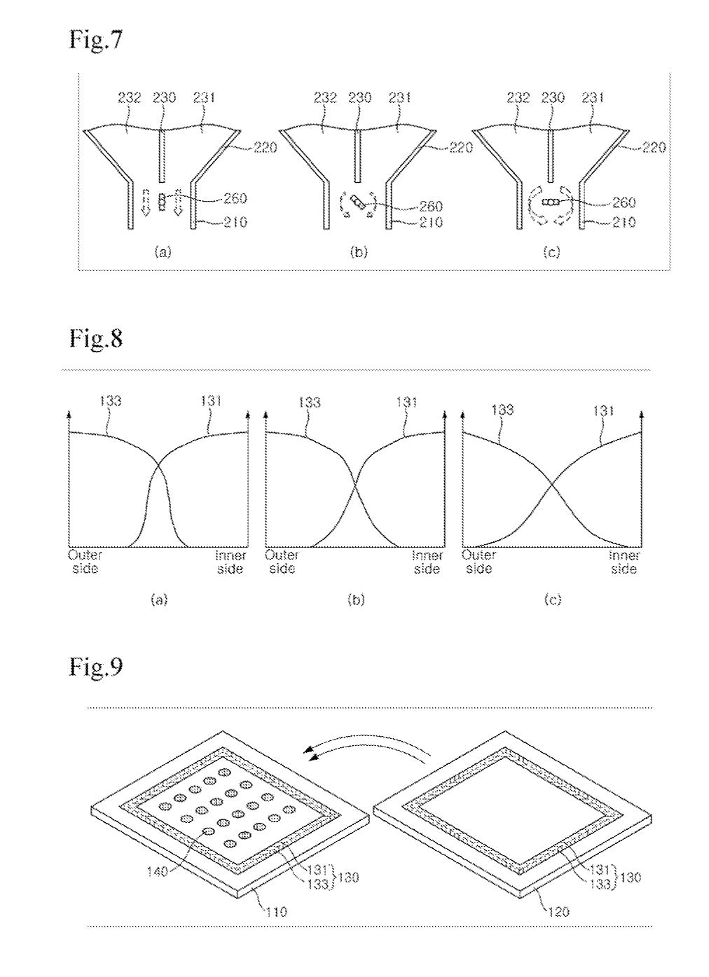

FIG. 7 shows nozzle regions of a sealant dispensing apparatus according to an embodiment of the present invention. FIG. 8 shows the mixing ratios of a resultant sealant coated on the substrate based on different orientations of a mixing controller, according to an embodiment of the present invention.

Referring to FIGS. 7 and 8, a sealant dispensing apparatus 200 includes a barrier capable of rotating in the injection nozzle 210. The barrier 260 serves to adjust the widths of the epoxy-based sealant 131, the mixed sealant 132, and the acrylic-based sealant 133. Accordingly, the mixing ratio of the resultant sealant layer coated on the substrates 110 and 120 can be adjusted as desired by using the vortex phenomenon of fluid and the injection pressure, as shown in FIG. 7. As shown in FIG. 7 (a), if the injection pressure is increased while adjusting the barrier 260 in a vertical direction, the epoxy-based sealant 131 and the acrylic-based sealant 131 in the first and second spaces 231 and 232 of the body 220 are coated on the substrates 110 and 120 without generating the vortex. In addition, as shown in FIG. 7 (b) and FIG. 7 (c), if the rotating angle of the barrier 260 is adjusted, the vortex phenomenon occurs, and thus, the amount of the mixed sealant in which the epoxy-based sealant 131 and the acrylic-based sealant 133 are mixed varies in a central area of the coated sealant layer. That is, as shown in the figures, as the vortex becomes stronger, the sealants are more smoothly mixed in the injection nozzle.

As described above, by means of the barrier 260 provided in the injection nozzle 210, the width of the epoxy-based sealant 131 placed at the inner side, the width of the acrylic-based sealant 133 provided at the outer side, and the width of the mixed sealant 132 disposed between the inner and outer sides can be adjusted, as illustrated in FIG. 8. Although it has been shown in some of the drawings that the widths of the epoxy-based sealant 131 and the acrylic-based sealant 133 are the same, the present invention is not limited thereto. That is, the widths may vary, depending on the processing conditions. For example, in a case where the leakage of liquid crystal is detected after the upper and lower substrates 120 and 110 are bonded and irradiated with UV, the width of the acrylic-based sealant 133 can be increased such that more sufficient sealing effect can be obtained. Further, in a case where foreign substances and contaminants are produced in the liquid crystal after the heat treatment, the uncured acrylic-based sealant 133 can be sufficiently sealed by increasing the width of the epoxy-based sealant 131.

Hereinafter, a method of manufacturing a liquid crystal display panel using the sealant dispensing apparatus will be described.

FIGS. 9 to 11 are perspective views illustrating a method of manufacturing a liquid crystal display panel according to an embodiment of the present invention.

Referring to FIG. 9, a lower substrate 110 and an upper substrate 120 are fabricated. That is, a thin film transistor, a gate line, a source line, a pixel electrode and a holding line are formed on the lower substrate 110. Further, a black matrix, a color filter and a common electrode are formed on the upper substrate 120.

A sealing pattern 130 is formed along the edges of the lower and upper substrates 110 and 120 by using the sealant dispensing apparatus 200 such that an epoxy-based sealant 131 is disposed on the inner side of the sealing pattern 130 and an acrylic-based sealant 133 is disposed on the outer side thereof. Further, liquid crystal 140 is dropped on the lower substrate 110.

In order to form the sealing pattern 130, the substrates 110 and 120 are mounted on a movable and rotatable stage (not shown). Then, the epoxy-based 131 and the acrylic-based sealant l33 are simultaneously coated on the substrates 110 and 120 through a single nozzle of the sealant dispensing apparatus 200 fixed to a fixing shaft according to an embodiment of the present invention. The substrates 110 and 120 are moved in fore-and-aft and left-and-right directions and rotated by 90 degrees at the vertex or corner region. The sealant dispensing apparatus 200 is also rotated by 90 degrees in accordance with the rotation of the substrates 110 and 120. Thus, a sealing pattern in the form of a rectangular band is formed along the edges of the substrate such that the epoxy-based sealant 133 is coated on the inner side of the sealing pattern 130 and the acrylic-based sealant 133 is coated on the outer side of the sealing pattern 130. As described above, the two sealants l31 and 133 having different properties can be coated on the substrates 110 and 120 at the same time, and thus, the process of bonding the substrates and scaling the liquid crystal can be simplified. In addition, the liquid crystal is dropped in the liquid crystal region corresponding to a region inside of the sealing pattern 130, by means of a liquid crystal dropping device.

Although it has been illustrated in the figures that the sealing pattern 130 is formed along the edges of both the lower and upper substrates 110 and 120, the present invention is not limited thereto. Alternatively, the sealing pattern 130 may be formed on any one of the lower and upper substrates 110 and 120. Further, although it has been illustrated that the liquid crystal 140 is dropped only on the lower substrate 110, the present invention is not limited thereto. Alternatively, the liquid crystal may be dropped either on the upper substrate 120 or on both the lower and upper substrates 110 and 120.

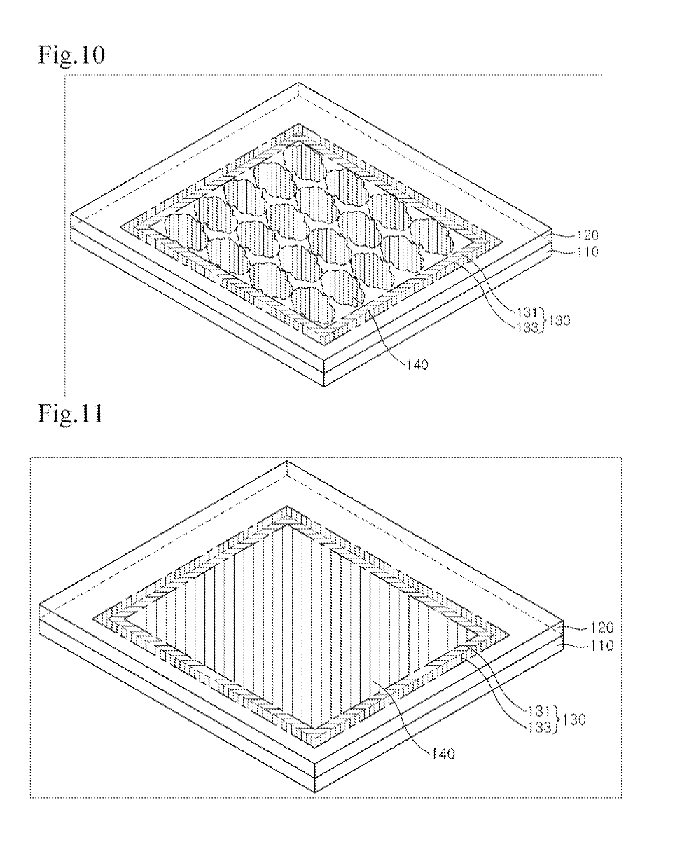

Referring to FIG. 10, the lower and upper substrates 110 and 120 are aligned and bonded and then irradiated with UV to thereby cure the acrylic-based sealant 133 provided on the outer side of the sealing pattern 130.

The lower substrate 110 and the upper substrate 120 are bonded with each other such that the color filter pattern formed on the upper substrate 120 and the pixel electrode pattern formed on the lower substrate are aligned. The bonded substrates are irradiated with UV to faster cure the acrylic-based sealant 133 provided on the outer side of the sealing pattern 130. In addition, when the upper and lower substrates 120 and 110 are bonded with each other, the liquid crystal 140 dropped on the lower substrate 110 is spread outward as shown in FIG. 10. At this time, the liquid crystal 140 dropped in an area adjacent to the sealing pattern 130 is spread toward the sealing pattern 130 but not leaked to the outside of the sealing pattern 130 since the acrylic-based 133 provided on the outer side of the sealing pattern 130 has been already cured by UV. Furthermore, since the epoxy-based sealant 131 is provided between the acrylic-based sealant 133 and the liquid crystal 140, it is possible to prevent the liquid crystal 140 from chemically reacting with the uncured acrylic-based sealant 133.

A spacer (not shown) in the form of a post is provided in a part of the sealing pattern formed between two substrates 110 and 120. Thus, when bonding the two substrates 110 and 120, it is possible to prevent the sealing patterns formed on the opposite substrates from being damaged and to maintain a certain gap between the two substrates 110 and 120. Further, when the two bonded substrates 110 and 120 are pressed, the liquid crystal dropped in a space between the two substrates 110 and 120 can be uniformly distributed due to the sealing pattern 130.

Referring to FIG. 11, the heat treatment is performed to cure the uncured sealant of the sealing pattern 130 such that a finished LCD panel can be manufactured.

The bonded substrates 110 and l20 in which the acrylic-based photocurable sealant 133 provided on the outer side of the sealing pattern 130 has been cured, is loaded into a heating furnace. Then, the substrates are heat treated for about 30 minutes to about 2 hours at a temperature of about 100° C. to about 150° C. to cure the epoxy-based thermosetting sealant 131 provided on the inner side of the sealing pattern 130 and the acrylic-based photocurable sealant 133 that may have been left uncured by the previous UV irradiation. The epoxy-based thermosetting sealant 13l having good adhesive strength is cured through this heat treatment, and thus, the adhesive strength between the upper and lower substrates 120 and 110 can be improved. The heat treatment is preferably performed such that the liquid crystal 140 cannot be damaged due to the heat treatment temperature and the uncured acrylic-based sealant 133 and epoxy-based sealant 131 can be sufficiently cured. During the heat treatment, the substrates 110 and 120 can be continuously pressed to improve the spreading characteristic of the liquid crystal. Even though the uncured acrylic-based photocurable sealant 133 provided on the outer side of the sealing pattern 130 can be cured and its molecular motion is increased during the above heat treatment process, the epoxy-based thermosetting sealant provided on the inner side of the sealing pattern 130 is cured to prevent the acrylic-based photocurable sealant 133 from being penetrated into the liquid crystal region.

A single LCD panel or a plurality of LCD panels may be formed on a large mother substrate and incorporate the sealing pattern comprising the acrylic-based sealant and the epoxy-based sealant in accordance with embodiments of the present invention.

According to the embodiments of the present invention. a sealant not reacting with liquid crystal and a sealant having a good curing rate can be simultaneously coated on the inner and outer sides of the liquid crystal region respectively by using a single sealant dispensing apparatus.

Further, the acrylic-based optical sealant used as the outer sealant can be cured faster through the UV irradiation to thereby prevent bursting of liquid crystal, and the epoxy-based thermosetting sealant used as the inner sealant can prevent a chemical reaction between the acrylic-based sealant and the liquid crystal.

In addition, since the inner and outer sealants can be simultaneously coated on the substrate, the process of bonding the substrate and sealing the liquid crystal can be simplified.

Furthermore, since a partition plate is provided in the sealant dispensing apparatus, sealants having different properties can be stored without being mixed with each other.

Moreover, since a barrier is further provided in an injection nozzle of the sealant dispensing apparatus, the mixing ratio of sealants to be coated on the substrate can be adjusted as desired.

Although the illustrative embodiments have been described herein with reference to the accompanying drawings, it is to be understood that the present invention is not limited to those precise embodiments. and that various other changes and modifications may be affected therein by one of ordinary skill in the related art without departing from the scope or spirit of the invention. All such changes and modifications are intended to be included within the scope of the invention as defined by the appended claims.

What is claimed is:

1. A sealant dispensing apparatus, comprising:
a body having an injection nozzle;
a partition plate for dividing an interior of the body into at least two spaces; and
an injection pressure application section for applying an injection pressure to the spaces divided by the partition plate.

2. The apparatus as recited in claim 1, wherein the interior of the body is divided into first and second spaces by the partition plate.

3. The apparatus as recited in claim 1, further comprising a sealant mixing ratio control member for controlling a mixing ratio of the sealant.

4. The apparatus as recited in claim 3, wherein the sealant mixing ratio control member includes a barrier positioned in the injection nozzle.

5. The apparatus as recited in claim 4, wherein the barrier rotates, and the mixing ratio varies with an angle defined between the barrier and the partition plate.

6. The apparatus as recited in claim 3, wherein the sealant mixing ratio control member includes an injection pressure controller for controlling the injection pressure of the injection pressure application section.

7. The apparatus as recited in claim 2, wherein when a width of the injection nozzle is defined as 1, a width of the first space of the injection nozzle is within a range of about 0.01 to about 0.8, and a width of the second space of the injection nozzle is within a range of about 0.01 to about 0.8.

8. The apparatus as recited in claim 1, wherein the partition plate extends from an upper end of the injection nozzle to an upper portion of the body.

9. The apparatus as recited in claim 1, further comprising a rotating member for rotating the body.

10. A liquid crystal display panel, comprising:
a lower substrate;
an upper substrate positioned opposite to the lower substrate;
a sealing pattern formed along edges of each of the upper and lower substrates; and
liquid crystal interposed inward of the sealing pattern,
wherein the sealing pattern comprises at least two sealants, and a ratio of the at least two sealants is varied along a predetermined direction of the sealing pattern.

11. The liquid crystal display panel as recited in claim 10, wherein inner and outer sides of the sealing pattern are provided with first and second sealants having different curing rates, respectively.

12. The liquid crystal display panel as recited in claim 11, wherein the first and second sealants have different curing rates based on temperature.

13. The liquid crystal display panel as recited in claim 12, wherein the first and second sealants have different curing rates based on light polymerization.

14. The liquid crystal display panel as recited in claim 12, wherein the first sealant is an acrylic-based or epoxy-acrylic hybrid based sealant, and the second sealant is an epoxy-based sealant.

15. The liquid crystal display panel as recited in claim 14, wherein a mixed sealant including the first and second sealants is formed at an interface between the first and second sealants.

16. The liquid crystal display panel as claimed in claim 15, wherein when a width of the sealing pattern is defined as 1, a width of the first sealant is within a range of about 0.01 to about 0.8, a width of the second sealant is within a range of about 0.01 to about 0.8, and a width of the mixed sealant is no more than about 0.95.

17. The liquid crystal display panel as recited in claim 10, wherein the upper substrate includes a color filter formed thereon and the lower substrate includes a TET pattern formed thereon.

18. A method of fabricating a liquid crystal display panel, comprising:
preparing a lower substrate having a pixel pattern formed thereon and an upper substrate having a color filter pattern formed thereon;
forming a sealing pattern along edges of at least one of the lower or upper substrates, the sealing pattern comprising a first sealant provided on an inner side thereof and a second sealant provided on an outer side thereof;
dropping liquid crystal inside of the sealing pattern;
bonding the lower and upper substrates such that the color filter pattern and the pixel pattern are aligned with each other;
irradiating ultraviolet light onto the lower and upper substrates to cure the second sealant; and
performing heat treatment to cure uncured sealant of the sealing pattern.

19. The method as recited in claim 18, wherein forming the sealing pattern comprises:
securing the lower or upper substrate on a movable and rotatable stage; and
coating the first and second sealant onto the edges of the lower or upper substrate using a sealant dispensing apparatus while moving and rotating the stage, the sealant dispensing apparatus including first and second spaces for accommodating the first and second sealants, respectively.

20. The method as recited in claim 19, wherein the first and second sealants have different curing rates based on temperature and light polymerization.

21. The method as recited in claim 19, wherein the first sealant is an acrylic-based sealant or epoxy-acrylic hybrid based sealant, and the second sealant is an epoxy-based sealant.

22. The method as claimed in claim 18, wherein forming the sealing pattern comprises:
securing the lower or upper substrate on a movable stage;
coating the first and second sealants onto the edges of the lower or upper substrate using a sealant dispensing apparatus while laterally moving the stage, the sealant dispensing apparatus including first and second spaces for accommodating the first and second sealants, respectively; and
rotating the sealant dispensing apparatus such that the first sealant is coated inward of the second sealant.
